(19) United States
(12) Patent Application Publication
(10) Pub. No.: US 2026/0017571 A1
(43) Pub. Date: Jan. 15, 2026

(54) LEARNING SYSTEM, LEARNING METHOD, AND COMPUTER READABLE MEDIUM

(71) Applicant: NEC CORPORATION, Minato-ku, Tokyo (JP)

(72) Inventor: Takeshi AKAGAWA, Tokyo (JP)

(73) Assignee: NEC CORPORATION, Minato-ku, Tokyo (JP)

(21) Appl. No.: 18/995,237

(22) PCT Filed: Aug. 12, 2022
(86) PCT No.: PCT/JP2022/030756

§ 371 Date: Jan. 16, 2025

(51) Int. Cl. G06N 20/20

(52) U.S. Cl. CPC G06N 20/20

(57) ABSTRACT

A learning system includes: a first learning unit configured to cause a global model generated by federated learning to learn first data included in the data set, to thereby generate a local model; a second learning unit configured to learn a first machine learning model by machine learning that uses second data among the data items included in the data set, the second data being different from the first data; an integration unit configured to integrate the local model or the global model with the first machine learning model; and a generation unit configured to generate a new global model using the local model.

### DESCRIPTION

### Technical Field The present disclosure relates to a learning system, a learning method, and a computer readable medium.

### Background Art

Patent Literature 1 discloses an information processing system that uses federated learning.

### CITATION LIST

### Patent Literature

[Patent Literature 1] International Patent Publication No. WO 2021/205959

### SUMMARY OF INVENTION

### Technical Problem

A federated learning technique for training local models using data sets owned by respective organizations and distributing a global model in which the local models are integrated has been proposed. In the federated learning technique, it is possible to keep the data sets used for learning confidential. However, if there is an organization that records a time-series change in the global model, it may be possible for this organization to infer learning data used to learn the most recent local model by reverse engineering the global model.

In view of the above circumstances, one of objects of example embodiments herein disclosed is to provide a learning system, a learning method, and a program for improving an accuracy of a machine learning model while preventing data owned by respective organizations from being leaked.

### Solution to Problem

A learning system according to a first aspect of the present disclosure includes: a first learning means for learning a first machine learning model by machine learning performed using first data having a high degree of confidentiality among data items included in a data set; a second learning means for causing a global model generated by federated learning to learn second data among the data items included in the data set, the second data being different from the first data, to thereby generate a local model; integration means for integrating the local model or the global model with the first machine learning model; and generation means for generating a new global model using the local model.

A learning method according to a second aspect of the present disclosure includes: learning a first machine learning model by machine learning performed using first data having a high degree of confidentiality among data items included in a data set; causing a global model generated by federated learning to learn second data among the data items included in the data set, the second data being different from the first data, thereby generating a local model; integrating the local model or the global model with the first machine learning model; and generating a new global model by using the local model.

A non-transitory computer readable medium according to a third aspect of the present disclosure stores a program for causing a computer to execute: processing for learning a first machine learning model by machine learning performed using first data having a high degree of confidentiality among data items included in a data set; processing for causing a global model generated by federated learning to learn second data among the data items included in the data set, the second data being different from the first data, thereby generating a local model; processing for integrating the local model or the global model with the first machine learning model; and processing for generating a new global model by using the local model.

### Advantageous Effects of Invention

According to the present disclosure, it is possible to provide a learning system, a learning method, and a program for improving an accuracy of a machine learning model while preventing data having a high degree of confidentiality from being leaked.

### BRIEF DESCRIPTION OF DRAWINGS

FIG. 1 is a block diagram showing a configuration of a learning system according to related art;

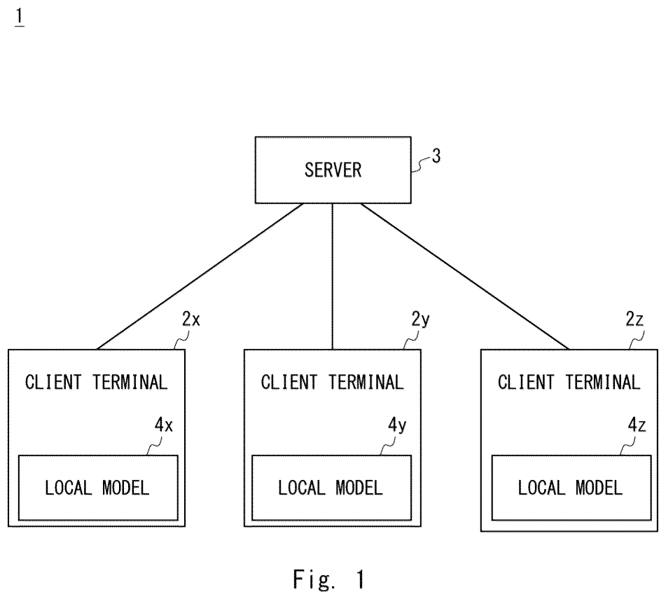

FIG. 2 is a block diagram showing a configuration of a learning system according to a first example embodiment;

FIG. 3 is a block diagram showing a configuration of a learning system according to a second example embodiment;

FIG. 4 is a block diagram showing a configuration of a client terminal according to the second example embodiment;

FIG. 5 is a flowchart showing a flow of an operation of a classification unit;

FIG. 6 is a block diagram showing a configuration of a learning system according to a third example embodiment; and

FIG. 7 is a block diagram showing a configuration of a learning system according to a fourth example embodiment.

### EXAMPLE EMBODIMENTS

<Circumstances leading to Example Embodiments>

First, an outline of federated learning will be described. First, a learning system 1 according to related art includes a client terminal 2x, a client terminal 2y, a client terminal 2z, and a server 3.

The client terminal 2x generates a machine learning model (this model will be referred to as a local model 4x) from a data set owned by an organization X. The client terminal 2x transmits the local model 4x to the server 3.

The client terminal 2y generates a machine learning model (this model will be referred to as a local model 4y) from a data set owned by an organization Y. The client terminal 2y transmits the local model 4y to the server 3.

The client terminal 2z generates a machine learning model (this model will be referred to as a local model 4z) from a data set owned by an organization Z. The client terminal 2z transmits the local model 4z to the server 3.

The server 3 generates a global model in which the local model 4x, the local model 4y, and the local model 4z are integrated. The server 3 may generate the global model by calculating, for example, an arithmetic mean of model parameters. Note that a method for integrating the model parameters is not limited to the arithmetic mean. The server 3 then distributes the global model to the client terminals 2x, 2y, and 2z.

Here, it is possible that data sets owned by respective organizations may include data that needs to be kept confidential from other organizations (e.g., data of a compound that is being developed). For example, there may be a case where one organization has started development of a compound that exhibits a specific effect and wants to keep this information secret. However, since the data set owned by this organization includes a large amount of data of the compound that exhibits the specific effect, it is possible that the start of development of the compound may be inferred by reverse engineering the global model. The inventors of the present application have conceived of the invention according to a first example embodiment based on the aforementioned circumstances.

### First Example Embodiment

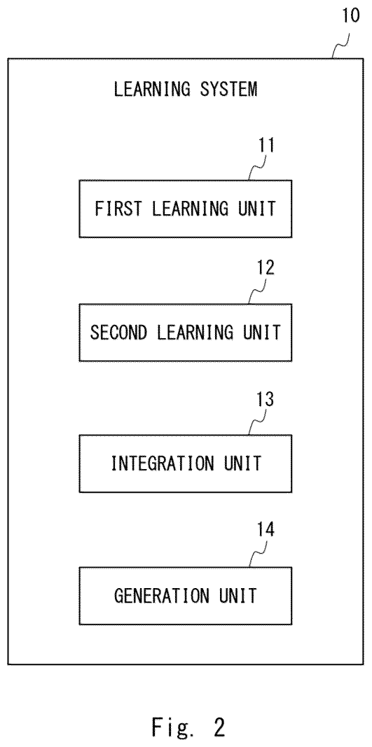

FIG. 2 is a block diagram showing a configuration of a learning system 10 according to a first example embodiment. The learning system 10 includes a first learning unit 11, a second learning unit 12, an integration unit 13, and a generation unit 14.

The first learning unit 11 learns a first machine learning model by machine learning performed using first data having a high degree of confidentiality among data items included in a data set.

The second learning unit 12 generates a local model by causing a global model generated by federated learning to learn second data among data items included in the data set, the second data being different from the first data.

The integration unit 13 integrates a first machine learning model with the local model or the global model. The integrated model will be referred to as a second machine learning model.

The generation unit 14 generates a new global model using the local model.

The learning system 10 according to the first example embodiment is able to generate a second machine learning model having a high accuracy while preventing data having a high degree of confidentiality from being leaked.

Note that the learning system 10 includes, as components that are not shown, a processor, a memory, and a storage apparatus. Further, this storage apparatus stores a computer program in which processing of a learning method according to this example embodiment is implemented. Then the processor loads a computer program into the memory from the storage apparatus to execute this computer program. Accordingly, the processor implements functions of the first learning unit 11, the second learning unit 12, the integration unit 13, and the generation unit 14.

Alternatively, each of the first learning unit 11, the second learning unit 12, the integration unit 13, and the generation unit 14 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as the processor.

Further, in a case where some or all of the components of the learning system 10 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the learning system 10 may be provided in the form of Software as a Service (SaaS).

### Second Example Embodiment

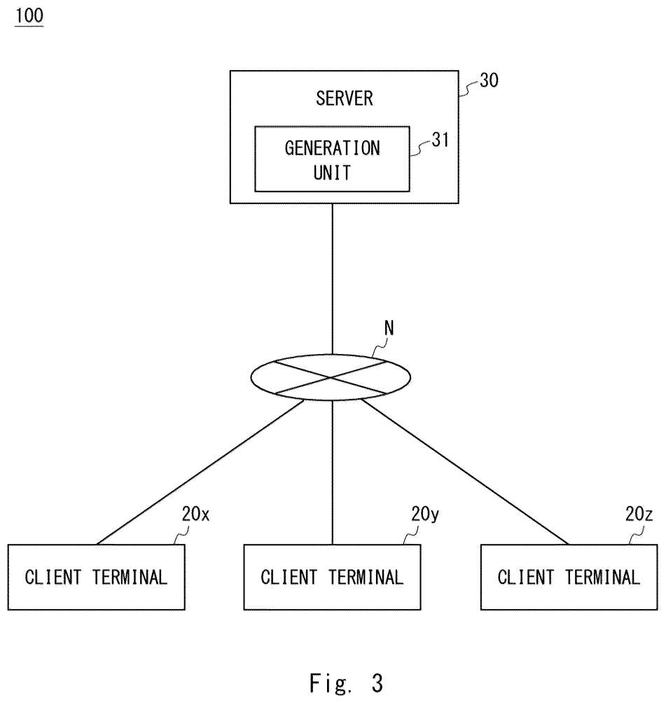

FIG. 3 is a block diagram showing a configuration of a learning system 100 according to a second example embodiment. The learning system 100 is a specific example of the learning system 10 according to the first example embodiment. The learning system 100 includes client terminals 20x, 20y, and 20z, and a server 30. Each of the client terminals is a terminal of an organization that uses the learning system 1 (e.g., a pharmaceutical or chemical company).

The client terminals 20x, 20y, and 20z and the server 30 are connected to each other in such a way that they can communicate with one another via a network N. The network N may be a wired network or a wireless network. The network N may be, for example, a Virtual Private Network (VPN).

In the following description, if it is not necessary to distinguish between the client terminals 20x, 20y, and 20z, they may be simply referred to as a client terminal 20. Note that the number of client terminals 20 is not limited to three, and it may be two, or four or greater.

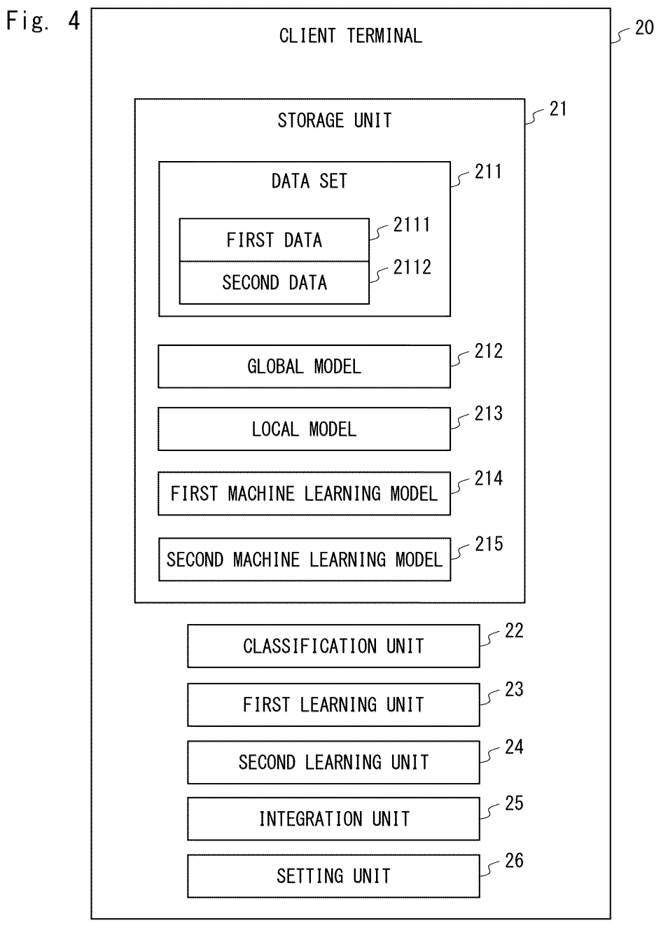

Next, with reference to FIG. 4, the client terminal 20 will be described. The client terminal 20 includes a storage unit 21, a classification unit 22, a first learning unit 23, a second learning unit 24, an integration unit 25, and a setting unit 26. The first learning unit 23 is a specific example of the first learning unit 11, the second learning unit 24 is a specific example of the second learning unit 12, and the integration unit 25 is a specific example of the integration unit 13.

The storage unit 21 is a storage that stores a data set 211 owned by each organization, a global model 212, a local model 213, a first machine learning model 214, and a second machine learning model 215.

The data set 211 includes a plurality of records. Each record is also called data or a data item. The data set 211 is, for example, a data set of compounds. In this case, the data set includes a plurality of data items (records), and values indicating a structure, characteristics, and the like of each compound are arranged in each data item. The structure of each compound is represented by a bit string or the like having a fixed length, and each bit of the bit string represents the presence or absence of a predetermined structure (e.g., benzene ring). Property values (e.g., a value of a tensile strength) may be values obtained by experiments or may be values obtained by a simulation or theoretical calculation. Properties include, for example, strength, modulus, transition temperature, optical properties, mechanical properties, and thermal properties. The data may include, in addition to or in place of the structure of each compound, the name of each compound or its composition.

The data set 211 includes a first data 2111 and a second data 2112. The first data 2111 is used for learning of the first machine learning model 214. The second data 2112 is used to learn the local model 213. The first data 2111 is not used to learn the local model 213. The first data 2111 and the second data 2112 are classified by the classification unit 22.

The first data 2111 and the second data 2112 may be each identified using a flag. Since it is possible that learning data may be inferred in federated learning, federated learning is performed by using only the second data 2112, which is a part of the data set. The first data 2111 is data (e.g., data of a compound which is under development) which is more confidential than the second data 2112.

The global model 212 is a global model in which local models learned in the plurality of client terminals 20 are integrated.

The local model 213 is a machine learning model that is learned by the second learning unit 24 that will be described later. The local model 213 is a machine learning model in which the global model 212 is caused to learn the second data 2112. The local model 213 is used by the server 30 to generate a new global model.

The first machine learning model 214 is a machine learning model learned by the first learning unit 23 that will be described later.

The second machine learning model 215 is a machine learning model generated by the integration unit 25 that will be described later.

The global model 212, the local model 213, the first machine learning model 214, and the second machine learning model 215 may be, for example, models for inferring properties from the structure of a compound.

The classification unit 22 classifies each of data items included in the data set 211 in the first data 2111 or the second data 2112. The data set 211 may include data that is not classified in either the first data 2111 or the second data 2112.

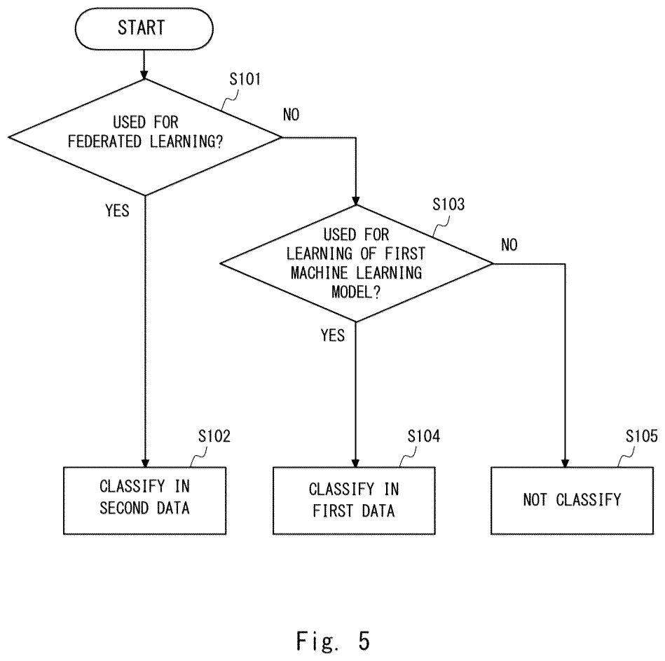

FIG. 5 is a flowchart showing one example of an operation of the classification unit 22. The processing in Steps S101-S105 is performed for each of data items included in the data set 211.

First, the classification unit 22 determines whether to use data for federated learning (Step S101). The classification unit 22 may determine that the data is used for federated learning in a case where a degree of data confidentiality is low. In the case where the data is used for federated learning (YES in Step S101), this data is classified in the second data 2112 (Step S102).

In a case where the data is not used for federated learning (NO in Step S101), the classification unit 22 determines whether or not to use the data for learning of the first machine learning model 214 (Step S102). The first machine learning model 214 is a machine learning model learned using data that is not used for federated learning. The classification unit 22 may determine that the data is used for learning of the first machine learning model 214 in a case where the data is highly reliable. Further, the classification unit 22 may determine that the data is not used for learning of the first machine learning model 214 in a case where the data has already been used for learning of the first machine learning model 214.

In a case where the data is used for learning of the first machine learning model 214 (YES in Step S103), this data is classified in the first data 2111 (Step S104). In a case where the data is not used for learning of the first machine learning model 214 (NO in Step S102), the classification unit 22 does not classify this data in either the first data 2111 or the second data 2112 (Step S105).

A period that is not used to learn the local model 213 may be set in each of the data items included in the data set 211. In this case, in Step S101, the classification unit 22 classifies data after an elapse of the period in the second data 2112. The greater the confidentiality of the data is, the longer this set period may be.

The first learning unit 23 generates a first machine learning model 214 by machine learning that uses the first data 2111. The first learning unit 23 is a specific example of the first learning unit 11 described above. The first learning unit 23 may generate the first machine learning model 214 by machine learning that uses both the first data 2111 and the second data 2112. Specifically, the first machine learning model 214 is a machine learning model learned by using only the data set 211 owned by one organization.

The first learning unit 23 may perform machine learning after converting the form of the first data into a form of data used to learn the local model 213 (hereinafter this form will be referred to as a predetermined form). The data set 211 is typically data collected by each of the client terminals 20 during research and development of compounds, etc., and may be stored in a form different from the predetermined form.

The second learning unit 24 causes the global model 212 to learn the second data 2112, to thereby generate the local model 213. The second learning unit 24 is a specific example of the aforementioned second learning unit 12. The local model 213 is transmitted to the server 30, and is used to generate a new global model. Note that the second learning unit 24 may convert the form of the second data 2112 into a predetermined form and cause the global model 212 to learn the second data 2112 converted into the predetermined form.

A weight for each second data 2112 in a case where the local model 213 is learned may be set. In this case, the second learning unit 24 learns the local model 213 based on the set weight. For example, the greater the reliability of the second data 2112 is, the higher the set weight may be. Since a model parameter of a machine learning model may be referred to as a weight, attention needs to be paid in such a way that this model parameter is distinguished from the weight of the learning data.

The integration unit 25 integrates the global model 212 or the local model 213 with the first machine learning model 214 to generate the second machine learning model 215. The integration unit 25 is a specific example of the integration unit 13 described above. The integration unit 25 may generate the second machine learning model 215 by calculating, for example, an arithmetic mean of a model parameter of the global model 212 or the local model 213 and a model parameter of the first machine learning model 214. The model parameter of the global model 212 or the local model 213 is referred to as a first model parameter. The model parameter of the first machine learning model 214 is referred to as a second model parameter. A method for integrating the models is not limited to the arithmetic mean. The integration unit 25 may calculate a weighted average of the first model parameter and the second model parameter based on an integration weight that will be described later.

The second machine learning model 215 is a machine learning model in which the global model 212 is integrated with the first machine learning model 214 learned by using the second data 2112 that is not used for federated learning.

Therefore, the second machine learning model 215 is more accurate than the global model 212. The second machine learning model 215 may be used, for example, to infer, by users who belongs to respective organization, the structure or properties of compounds.

The setting unit 26 sets an integration weight, which is a weight of the first machine learning model 214 in a case where the global model 212 or the local model 213 is integrated with the first machine learning model 214. The setting unit 26 may set the integration weight in accordance with input to the client terminal 20.

Specifically, the greater the reliability of the first machine learning model 214 is as compared to that of the global model 212 and so on, the higher the set integration weight is. For example, the greater the amount of the first data 2111 is as compared to the amount of the second data 2112, the higher the set integration weight may be. Further, the smaller the number of client terminals 20 participating in federated learning is, the higher the set integration weight may be. This is because, in a case where the number of client terminals 20 is small, the accuracy of the global model 212 is low.

Referring next to FIG. 3, the server 30 will be described. The server 30 includes a generation unit 31. The generation unit 31 is a specific example of the generation unit 14 described above.

The generation unit 31 integrates a local model 213 learned in the client terminal 20x, a local model 213 learned in the client terminal 20y, and a local model 213 learned in the client terminal 20z to generate a new global model. The generation unit 31 distributes the new integrated global model to the client terminal 20x, the client terminal 20y, and the client terminal 20z. Therefore, the information on the first data 2111 does not leak from the new global model.

In a case where the server 30 manages data sets of respective organizations, the first learning unit 23, the second learning unit 24, and the integration unit 25 may be provided in the server 30.

The learning system according to the second example embodiment is able to generate a second machine learning model having a high accuracy while preventing the first data from being leaked.

### Third Example Embodiment

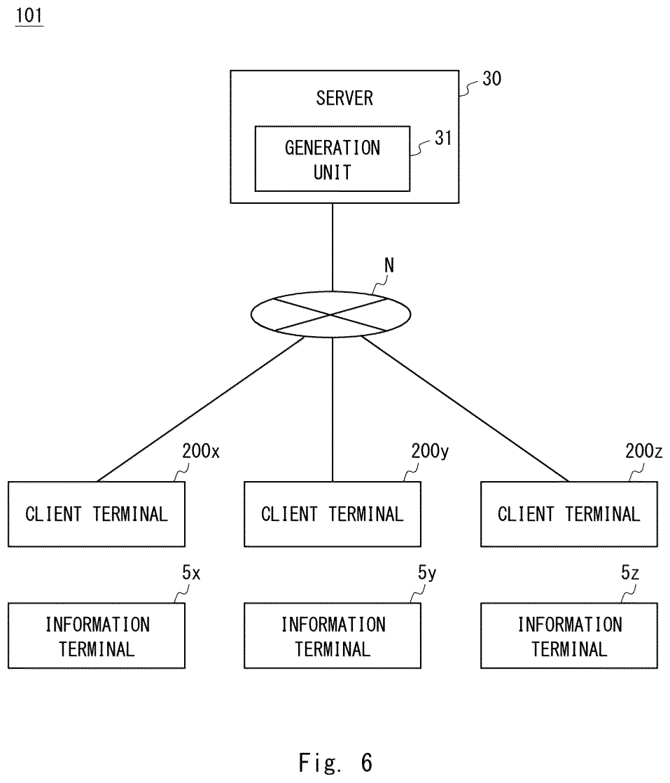

FIG. 6 is a block diagram showing a configuration of a learning system 101 according to a third example embodiment. The learning system 101 is a modified example of the learning system 100 described above. FIG. 6 is different from FIG. 3 in that the client terminals 20x, 20y, and 20z shown in FIG. 3 are replaced by client terminals 200x, 200y, and 200z in FIG. 6, and information terminals 5x, 5y, and 5z, which are not provided in FIG. 3, are added in FIG. 6. The elements whose functions are the same as those in the second example embodiment are denoted by the same reference symbols, and descriptions thereof will be omitted.

The client terminals 200x, 200y, and 200z are connected to an external network N of each organization. If it is not necessary to distinguish between the client terminals 200x, 200y, and 200z, they are simply referred to as a client terminal 200.

The information terminal 5x is a terminal that manages a data set owned by an organization X, the information terminal 5y is a terminal that manages a data set owned by an organization Y, and the information terminal 5z is a terminal that manages a data set owned by an organization Z. If it is not necessary to distinguish between the information terminals 5x, 5y, and 5z, they are simply referred to as an information terminal 5.

Data acquired in a research and development department of each organization is newly registered in the information terminal 5. Unlike the client terminal 20, the information terminal 5 is not connected to the external network N. It is therefore possible to prevent data managed by the information terminal 5 from being leaked.

Like the client terminal 20 shown in FIG. 4, the information terminal 5 includes a storage unit 21, a classification unit 22, a first learning unit 23, a second learning unit 24, an integration unit 25, and a setting unit 26. Note that the client terminal 200 does not include these functions.

Since the information terminal 5 is not connected to the external network N, a global model 212 is transferred from the client terminal 200 to the information terminal 5 using a storage medium such as a Universal Serial Bus (USB) memory. Since the information terminal 5 is not connected to the network N, it is possible to prevent a first machine learning model 214 and a second machine learning model 215 from being leaked. It is therefore possible to prevent a first data 2111 from being inferred by reverse engineering.

With reference to FIG. 6, the client terminal 200 transmits a local model 213 generated by the information terminal 5 to a server 30. Further, the client terminal 200 receives the global model 212 generated by the server 3.

The learning system according to the third example embodiment achieves effects similar to those in the second example embodiment. Since the information terminal 5 is separated from the external network, it is possible to further reduce the risk that the first data may be leaked.

### Fourth Example Embodiment

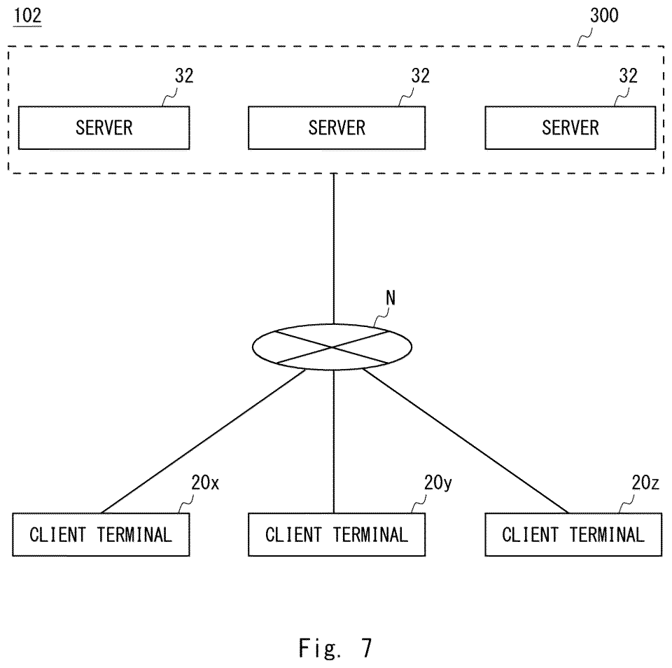

FIG. 7 is a block diagram showing a configuration of a learning system 102 according to a fourth example embodiment. The learning system 102 is a modified example of the learning system 100. FIG. 7 is different from FIG. 3 in that the server 30 shown in FIG. 3 is replaced by a server group 300 in FIG. 7. The server group 300 includes a plurality of servers 32. Note that the number of servers 32 is not limited to three. However, considering that secure computation is executed, the number of servers 32 is preferably three or greater.

The server group 300 integrates global models 212 in secure computation and transmits a result of the secure computation to client terminals 20x, 20y, and 20z.

Like in the second example embodiment, each of client terminals 20 learns a local model 213 by machine learning that uses second data 2112. Then, each of the client terminals 20 divides each parameter of the local model 213 into a plurality of (e.g., three) shares, and transmits the plurality of shares to the plurality of servers 32.

Each server 32 performs secure computation for computing the global model 212 by using the received shares. Each server 32 may generate the global model 212 at predetermined times. The local models cannot be known from the shares, and thus computation that uses shares can be referred to as secure computation. A plurality of servers 32 may perform multi-party computation (MPC) in a collaborated manner. Since an amount of computations required to integrate local models 213 is sufficiently small, it is considered that the server group 300 can perform secure computation in a realistic time.

The fourth example embodiment also achieves effects similar to those in the second example embodiment. Further, according to the fourth example embodiment, it is possible keep computations for integrating global models confidential.

The above-described program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present application has been described above with reference to the example embodiments, the present application is not limited to the above-described example embodiments. Various changes that can be understood by those skilled in the art within the scope of the present application can be made to the configurations and the details of the present application.

### REFERENCE SIGNS LIST

### 1, 10, 100, 101, 102 Learning System

### 2, 2x, 2y, 2z, 20, 20x, 20y, 20z, 200, 200x, 200y, 200z Client Terminal

### 21 Storage Unit

### 211 Data Set

### 2111 First Data

### 2112 Second Data

### 212 Global Model

### 4, 4x, 4y, 4z, 213 Local Model

### 214 First Machine Learning Model

### 215 Second Machine Learning Model

### 22 Classification Unit

### 11, 23 First Learning Unit

### 12, 24 Second Learning Unit

### 13, 25 Integration Unit

### 26 Setting Unit

### 3, 30, 32 Server

### 14, 31 Generation Unit

### 300 Server Group

### 5, 5x, 5y, 5z Information Terminal

### N Network

What is claimed is:

1. A learning system comprising:
at least one memory storing instructions and
at least one processor configured to execute the instructions to:
learn a first machine learning model by machine learning performed using first data having a high degree of confidentiality among data items included in a data set;
cause a global model generated by federated learning to learn second data among the data items included in the data set, the second data being different from the first data, to thereby generate a local model;
integrate the local model or the global model with the first machine learning model; and
generate a new global model using the local model.

2. The learning system according to claim 1, comprising an information terminal that is not connected to an external network,
wherein the at least one processor is included in the information terminal.

3. The learning system according to claim 1, wherein the at least one processor is further configured to execute the instructions to:
set an integration weight, which is a weight of the first machine learning model in a case where the local model or the global model is integrated with the first machine learning model.

4. The learning system according to claim 1, wherein the first data and the second data are each identified using a flag.

5. The learning system according to claim 1, wherein
a period that is not used to learn the local model is set in each data item included in the data set, and
the at least one processor is further configured to execute the instructions to:
classify data after an elapse of the period in the second data.

6. The learning system according to claim 1, wherein a weight for each second data in a case where the local model is learned is set.

7. The learning system according to claim 1, wherein the at least one processor is further configured to execute the instructions to:
perform the machine learning after converting a form of the first data into a form of data used to learn the local model.

8. A learning method comprising:
learning a first machine learning model by machine learning performed using first data having a high degree of confidentiality among data items included in a data set;
causing a global model generated by federated learning to learn second data among the data items included in the data set, the second data being different from the first data, thereby generating a local model;
integrating the local model or the global model with the first machine learning model; and
generating a new global model by using the local model.

9. A non-transitory computer readable medium storing a program for causing a computer to execute:
processing for learning a first machine learning model by machine learning performed using first data having a high degree of confidentiality among data items included in a data set;
processing for causing a global model generated by federated learning to learn second data among the data items included in the data set, the second data being different from the first data, thereby generating a local model;
processing for integrating the local model or the global model with the first machine learning model; and
processing for generating a new global model by using the local model.
